(19) United States
(12) Patent Application Publication
(10) Pub. No.: US 2011/0216923 A1
(43) Pub. Date: Sep. 8, 2011

(54) STRUCTURE OF FLEXIBLE SPEAKER

(76) Inventors: Dar-Ming Chiang, Hsinchu City (TW); Shu-Ru Lin, Taichung County (TW); Yan-Ren Chen, Taichung County (TW); Tsung-Hung Wu, Hsinchu County (TW); Shen-Long Liang, Hsinchu County (TW)

(21) Appl. No.: 12/792,743

(22) Filed: Jun. 3, 2010

(30) Foreign Application Priority Data
Mar. 8, 2010 (TW) 099106600

(51) Int. Cl. H04R 19/01

(52) U.S. Cl. 381/186; 381/191

(57) ABSTRACT

A flexible speaker structure, includes, a first electret film having a first surface, a second electret film having a second surface, a conductive film positioned between the first electret and the second electret, a first spacer disposed on the first surface for supporting a first electrode, and a second spacer disposed on the second surface for supporting a second electrode. A first interior angle is defined by the first electret and the first spacer, and the first interior angle is between 60 to 80 degrees.

### BACKGROUND OF THE INVENTION

1. Field of the Invention

The present invention relates to a structure of a flexible speaker, and more particularly, to a structure of an electret speaker which has improved range of frequencies and efficiency.

2. Description of the Prior Art

In general, speaker are classified, based on a method of converting mechanical vibration into electric signals, into a carbon speaker, a crystal speaker, a moving-coil speaker, a velocity speaker, and a condenser speaker.

The condenser type is widely used as a small-size speaker. However, the condenser speaker needs a battery for applying a voltage to a condenser. Since the battery occupies a large space, the size of the condenser speaker cannot easily be reduced.

In order to achieve a small-size speaker, an electret speaker which has an electrized electret having quasi-permanent charges was proposed recently.

A conventional electret speaker comprises two electrodes, and an electrized electret film is disposed between two electrodes. The electrized electret film has a permanent voltage built inside. When an audio signal is input to the electrode, the voltage of the electrode will change and forms an electrostatic force toward the electrized electret film. Then the electret film vibrates to generate sounds.

The following is the electrostatic equation for calculating the electrostatic force.

$$F = \frac{{e}_{0} {SV}_{P}}{{d}^{2}} {e}_{m} \qquad ( 1 )$$

Wherein F is electrostatic force, e₀ is the dielectric constant of air. S is the area of a vibrating film, Vₚ is the bias of the vibrating film and d is the distance between the vibrating film and the electrode.

Based on eq. (1), when a typical condenser speaker has a small distance between the electrode and the vibrating film, a larger area of the vibrating film, or a larger bias of the vibrating film, the electrostatic force will be greater. Therefore, the efficiency of the condenser speaker will be better.

However, as for an electret speaker the electrostatic force can not be simply calculated by eq. (1). Because the electrized electret film is very flexible, the electrized electret film will attach on the electrode partly.

The bias of the electrized electret film influences the attaching area of the electrized electret film. Based on eq. (1), the higher bias is, the greater the electrostatic force is. The greater electrostatic force leads to better efficiency of the speaker. However, higher bias results in larger attaching area, and shorter distance between the electrode and the electrized electret film. The larger attaching area decreases the efficiency and range of frequencies of the speaker, but the shorter distance increases the efficiency of the speaker.

As a result, numerous parameters influence the efficiency and range of frequencies of the electret speaker. To optimize the efficiency and range of frequencies of the electret speaker is still a challenge.

### SUMMARY OF THE INVENTION

According to a preferred embodiment of the present invention, a structure of flexible speaker includes: a first electret film including a first surface, a second electret film including a second surface, a conductive film disposed between the first electret film and the second electret film, a first spacer including a plurality of strip elements disposed on the first surface of the first electret film for supporting a first electrode, wherein the first electret film and the first spacer define a first interior angle between 60 to 88 degrees and a second spacer disposed on the second surface of the second electret film for supporting a second electrode.

According to another preferred embodiment of the present invention, a structure of flexible speaker includes: a first electret film including a first surface, a second electret film including a second surface, a conductive film disposed between the first electret film and the second electret film, a first spacer including a plurality of post elements disposed on the first surface of the first electret film for supporting a first electrode, wherein the first electret film and the first spacer define a first interior angle between 60 to 88 degrees and a second spacer disposed on the second surface of the second electret film for supporting a second electrode.

The spacers separate the electret films from the electrode so that the electret film does not attach on the electrode entirely. The electret film that does not attach on the electrode forms a vibrating region capable of producing sounds. The density of the spacers, the height of spacers may influence the size of the vibrating region. If the density of the spacers is too high, the vibrating region may be occupied by the spacers, if the density of the spacers is too low, a great part of the electret film may attach on the electrode, and the vibrating region is sacrificed. In the present invention, the spacer density, height, and width of the spacer are optimized so that the flexible speaker can produce a wider range of frequencies and higher efficiency.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 depicts a sectional view of a flexible speaker schematically.

FIG. 2 depicts an exploded view of the flexible speaker according to a first embodiment of the present invention.

FIG. 3a depicts a localized view of FIG. 1 according to the first preferred embodiment of the present invention.

FIG. 3b depicts a localized view of FIG. 1 according to the first preferred embodiment of the present invention.

FIG. 4 depicts a varied type of the first embodiment schematically.

FIG. 5 depicts an exploded view of the flexible speaker according to a second embodiment of the present invention.

FIG. 6 depicts a varied type of the arrangement of the first spacer.

FIG. 7a depicts a localized view of FIG. 1 according to the second preferred embodiment of the present invention.

FIG. 7b depicts a localized view of FIG. 1 according to the second preferred embodiment of the present invention.

FIG. 8 depicts a relation between intensity vs. frequency of the flexible speaker according to a first preferred embodiment.

### DETAILED DESCRIPTION

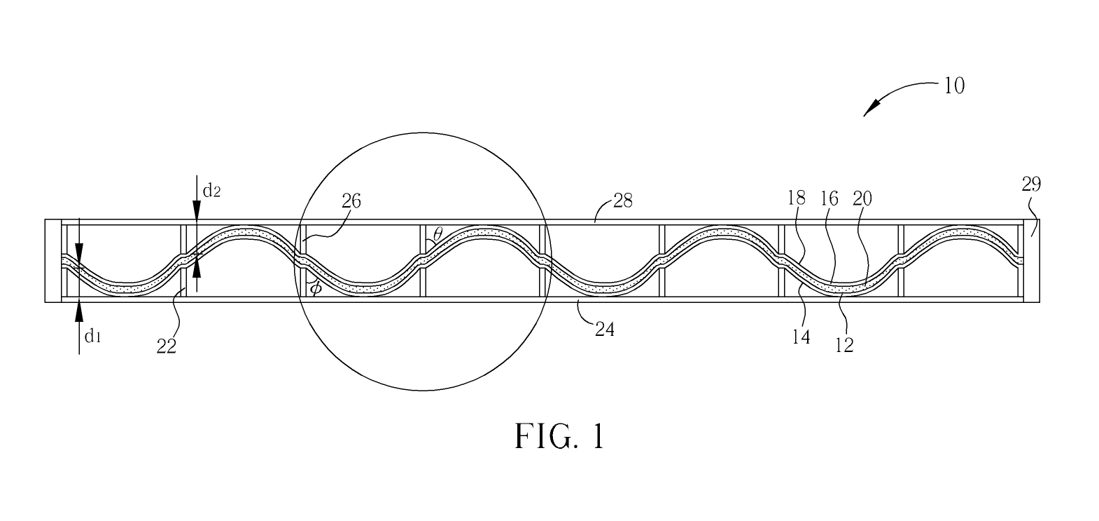

FIG. 1 depicts a sectional view of a flexible speaker schematically. As shown in FIG. 1, a flexible speaker 10 includes a first electret film 12 having a first surface 14, a second electret film 16 having a second surface 18, a conductive film 20 disposed between the first electret film 12 and the second electret film 16. A first spacer 22 is disposed on the first surface 14 of the first electret film 12 for supporting a first electrode 24, a second spacer 26 is disposed on the second surface 18 of the second electret film 16 for supporting a second electrode 28. The first electrode 24 and the second electrode 28 have numerous holes (not shown). The first spacer 22 and the second spacer 26 are formed by materials comprising rubber, silica gel, glue, hot melt adhesive, double sided tape or plastic. The first spacer 22 and the second spacer 26 can be formed by utilizing press forming or rolling forming to form the first spacer 22 and the second spacer 26 on the first and second electrodes 22, 28.

The first electret 12 and the second electret 16 can be made of electrized polytetrafluoroethylene (PTFE), electrized fluorinated ethylene propylene (FEP), electrized polyvinylidene fluoride (PVDF), electrized fluoroploymer (PP), electrized polypropylene (PE), electrized polyethylene (PI), electrized polyimide, electrized cyclic olefin copolymer (COC), electrized complex of COC copolymer, or other electret materials. The method of electrizing the first electret 12 and the second electret 16 may be corona charging to permanently maintain charges inside the first electret 12 and the second electret 16. The electrized first electret 12 and electrized second electret 16 may have bias between 50V to 2000V.

In addition, the first and second electret films 12, 16, the first and second electrodes 24, 28, the first and second spacers 22, 26, and the conductive film 20 may be made of transparent materials. The first and second electrodes 24, 28 may be made of indium tin oxide (ITO), indium zinc oxide (IZO), zinc tin oxide (ZTO), aluminum zinc oxide (AZO), gallium zinc oxide (GZO), or other transparent conductive oxides, but are not limited to it. The first and second electrodes 24, 28 can also be made of gold, silver, copper, iron, aluminum, tin or other conductive materials. The methods for forming the first and second electrodes 24, 28 may include evaporating, sputtering, depositing electroplating, or spin coating a conductive layer on a porous material. Moreover, the first and second electret films 12, 16 may be porous metal plates or metal grids. In addition, the first and second electret films 12, 16, the first and second electrodes 24, 28, the first spacer and the second spacer 22, 26 and the conductive film 20 may be flexible materials. Moreover, the flexible speaker 10 can further include an insulating material 29, and a water-repellent material (not shown). The insulating material 29 can seal edges of the first and second electrode 24, 28 so as to prevent the first and second electrodes 24, 28 from contacting the conductive film 20. The insulating material 29 may also seal edges of the flexible speaker 10 to prevent the first and second electrodes 24, 28 from peeling off from the porous material when the flexible speaker 10 is bent or when the first and second electret films 12, 16 are vibrating. The flexible speaker 10 may be sealed by using wood strips or plastic plates to laminate the front side and the back side of the flexible speaker 10. In other ways, the edges of the flexible speaker 10 can be sealed by sewing edges by insulating threads. The water-repellent material may be formed on the surface of the flexible speaker 10 by coating or sputtering. During operation, the first and the second electret films 12, 16 may both bend to the first electrode 24 and the first electret film 12 attaches on the first electrode 24 due to electrostatic force. In another embodiment, the first and the second electret films 12, 16 may both bend to the second electrode 28 and the second electret film 16 attaches on the second electrode 28. Sometimes, the first and the second electret films 12, 16 may separate from each other and attach on the first electrode 24, and the second electrode 28 respectively. The bending and attaching direction of the first and second electret films 12, 16 shown in FIG. 1 is just to make an example. Moreover, the first electrode 24, and the second electrode 28 are also flexible, due to electrostatic force, the first electrode 24, and the second electrode 28 may distort and bend toward the first and second electret films 12, 16. However, the distortions of the first electrode 24, and the second electrode 28 are small and therefore are omitted for the sake of brevity.

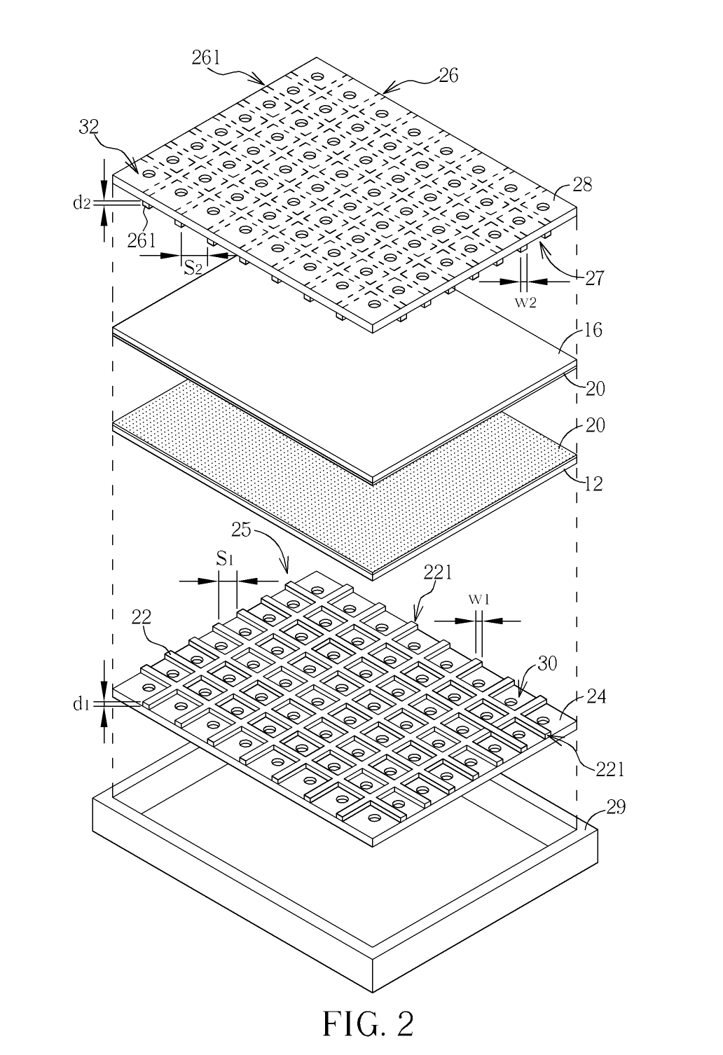

FIG. 2 depicts an exploded view of the flexible speaker according to a first embodiment of the present invention. As show in FIG. 2, the first spacer 22 includes numerous strip elements 221. The strip elements 221 cross with each other to form a grid pattern 25 having a plurality of regions 30. The shape of each of the region 30 may be a circle, rectangular, ellipse, polygon or other shapes. Each of the regions 30 is in a shape of rectangular in FIG. 2, but is not limited to it. Each of the strip elements 221 has a width W₁ between 2 to 10 mm. Between two adjacent strip elements 221 there is a space S₁ between 8 to 100 mm. In addition, each of the strip elements 221 has a height d₁ between 50 to 1500 μm. Similarly, the second spacer 26 including numerous strip elements 261 forms another grid pattern 27. The grid pattern 27 has numerous regions 32. The shape of each of the region 32 may be a circle, rectangular, ellipse, polygon or other shapes. Each of the strip elements 261 has a width W₂ between 2 to 10 mm. Between two adjacent strip elements 261 there is a space S₁ between 8 to 100 mm. In addition, each of the strip elements 261 has a height d₂ between 50 to 1500 μm.

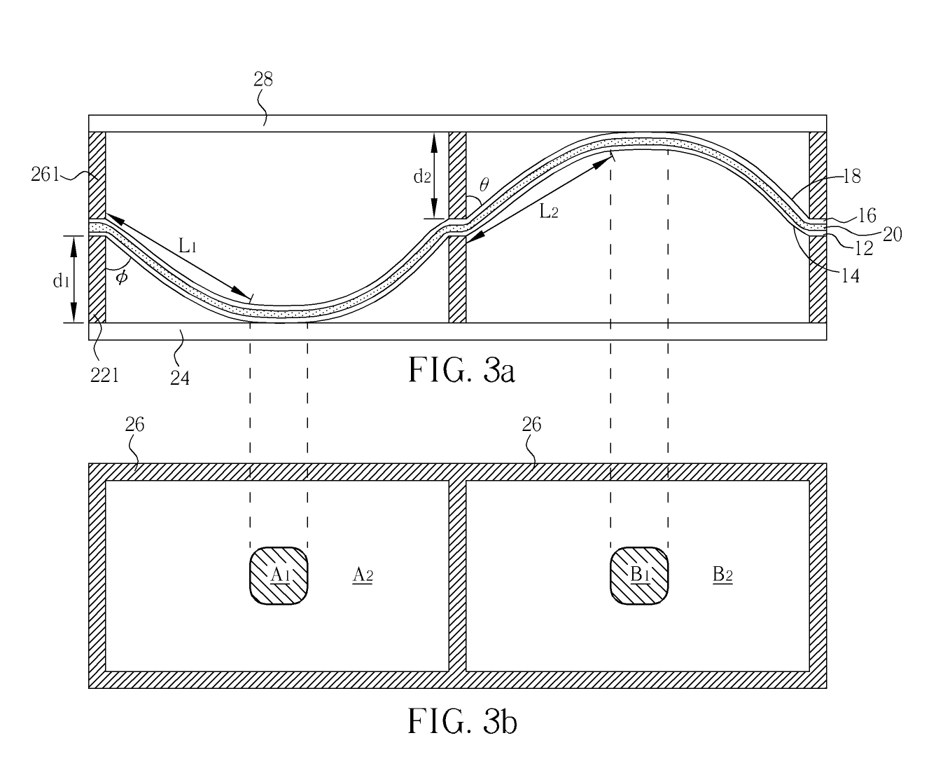

FIG. 3a depicts a localized view of FIG. 1 according to the first preferred embodiment of the present invention. FIG. 3b depicts a localized view of FIG. 1 according to the first preferred embodiment of the present invention. Please refer to FIG. 1, 3a, 3b. Since the electret film is flexible, even without any audio signal, part of the electrized first electret film 12 may contact with the first electrode 24 to form a first attaching region A₁. Since the first spacer 32 disposed between the first electret film 12 and the first electrode 24 supports the first electret film 12, part of the first electret film 12 forms a first vibrating region A₂ which does not contact with the first electrode 24. The vibrating region A₂ vibrates when the first electrode 24 receives an audio signal. Similarly, the second electret film 12 has a second attaching region B₁ contacts with the second electrode 28, and a second vibrating region B₂ vibrates when the second electrode 28 receives an audio signal.

When the first spacer 22 and the second spacer 26 are arranged at the aforesaid width W₁, W₂, space S₁, S₂, height d₁, d₂ and the first electret film 12 and the second electret film 16 do not vibrate (no audio signal input), a distance L₁ between an edge of the first attaching region A₁ and the corresponding strip element 221 is 2 to 30 times of the height d₁ of the corresponding strip element 221; and a distance L₂ between an edge of the second attaching region B₁ and the corresponding strip element 261 is 2 to 30 times of the height d₂ of the corresponding strip element 261. Meanwhile, the first electret film 12 and the first spacer 22 define a first interior angle φ between 60 to 80 degrees; the second electret film 16 and the second spacer 26 define a second interior angle θ between 60 to 80 degrees.

At this point, the first electret film 12 and the second electret film 16 have an optimized vibrating region to improve the range of frequencies and efficiency of the flexible speaker 10.

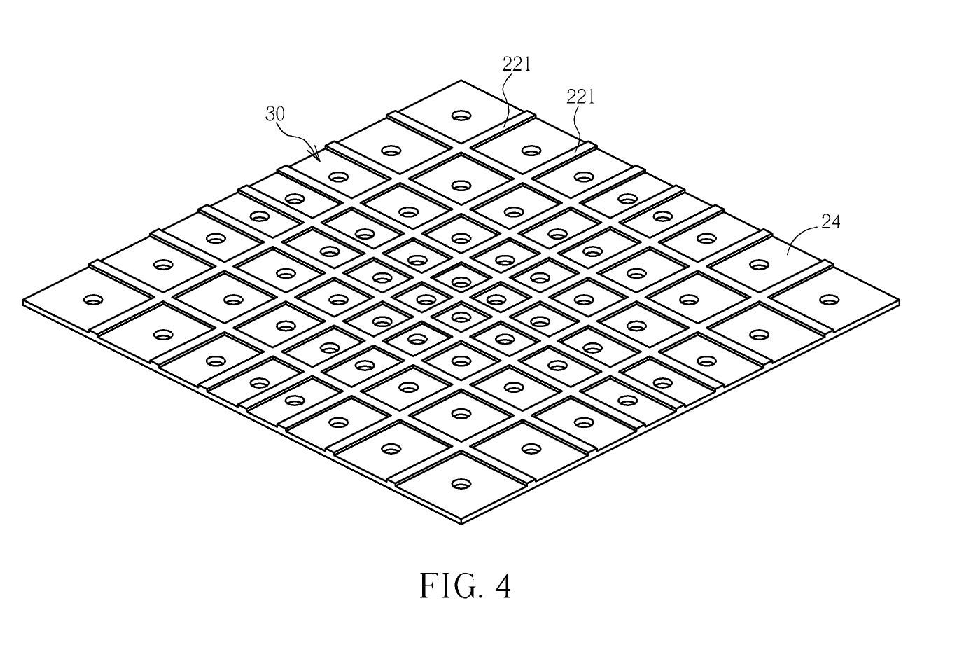

FIG. 4 depicts a varied type of the first embodiment schematically. As shown in FIG. 1, the size of each region of the grid pattern does not have to be identical. For example, as shown in FIG. 4, the regions 30 formed by the strip elements 221 near an edge of the first electret film 12 are larger than the regions 30 formed by the strip elements 221 farther from the edge of the first electret film 12. Based on different requirements, the regions 30 near the edge of the first electret film 12 can be smaller than the strip elements 221 farther the edge of the first electret film 12. Furthermore, the strip elements 261 may have the same arrangement as the strip elements 221. For instance, regions (not shown) formed by the strip elements 261 near an edge of the second electret film 26 are larger than the regions formed by the strip elements 261 farther from the edge of the second electret film 26.

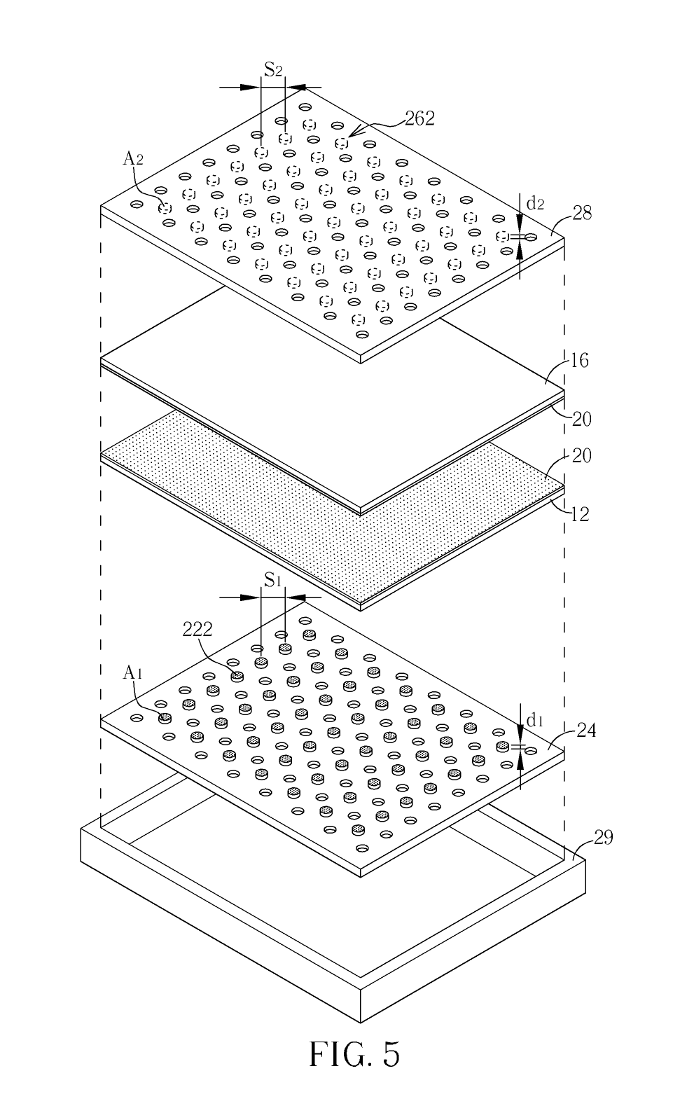

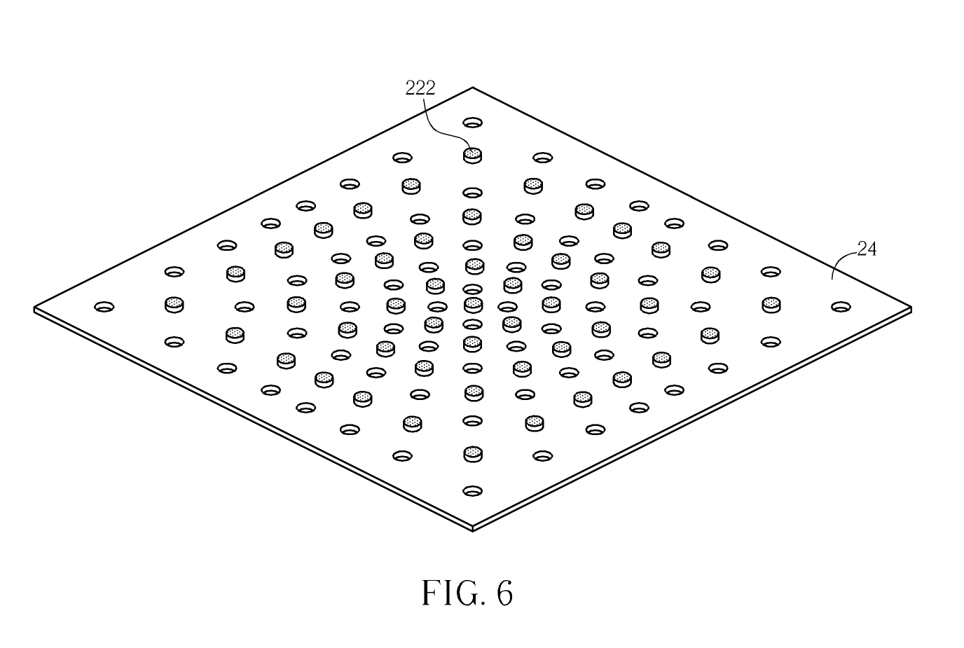

FIG. 5 depicts an exploded view of the flexible speaker according to a second embodiment of the present invention. FIG. 6 depicts a varied type of the arrangement of the first spacer. The difference between the first embodiment and the second embodiment is that the first spacer and the second spacer include post elements rather than strip elements. Other elements in the second preferred embodiment have same functions and same locations as that in the first preferred embodiment. For the sake of simplicity, elements with the same functions are designated with the same numeral.

As shown in FIG. 1 and FIG. 5, the first spacer 22 may include numerous post elements 222 disposed between the first electret film 12 and the first electrode 24. Each of the post elements 222 has a space S₁ between the adjacent post element 222, and the space S₁ is about 8 to 100 mm. Each of the post elements 222 has a height d₁ between 50 to 1500 μm. Each of the post elements 222 has a cross-sectional area between 0.5 to 15 mm². The shape of a cross-section of each post element 222 may be a circle, rectangular, ellipse, polygon or other shapes. In FIG. 5, the shape of the cross-section of each post element 222 is exemplified as circle. The construction of the second spacer 26 is substantially identical as that of the first spacer 22. The second spacer 26 also has numerous post elements 262. Each post of the elements 262 has a space S₂ between the adjacent post element 262, and the space S₂ is about 8 to 100 mm. Each of the post elements 262 has a height d₂ between 50 to 1500 μm. Each of the post elements 262 has a cross-sectional area between 0.5 to 15 mm². The shape of a cross-section of each post element 262 may be a circle, rectangular, ellipse, polygon or other shapes.

In addition, the space S₁ between the two adjacent post elements 222 can be altered based on the location of the post elements 222. Similarly, the space S₂ between the two adjacent post elements 262 can also be altered based on the location of the post elements 262. For example, as shown in FIG. 6, the space S₁ between two adjacent post elements near an edge of the first electret 12 is larger than the space S₁ between two adjacent post elements farther from the edge of the first electret 12.

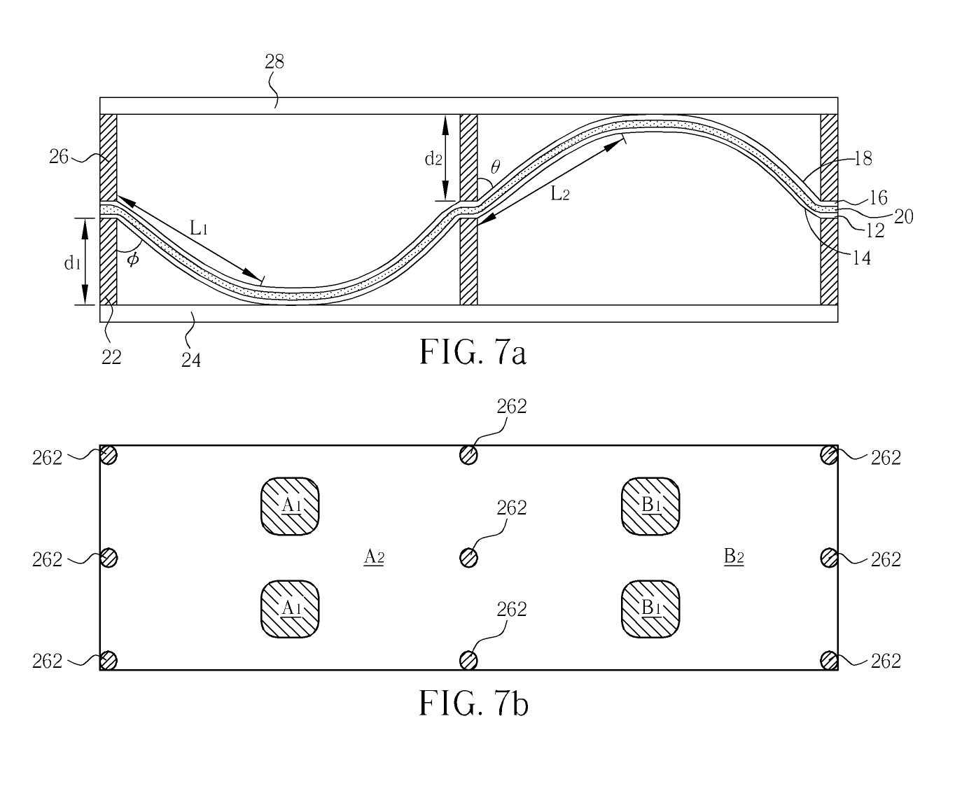

FIG. 7a depicts a localized view of FIG. 1 according to the second preferred embodiment of the present invention. FIG. 7b depicts a localized view of FIG. 1 according to the second preferred embodiment of the present invention.

As shown in FIGS. 7a, and 7b, part of the first and second electret films 12, 16 are attached on the first and second electrodes 24, 28 respectively because of the electrostatic force. The first electret film 12 has a first attaching area A₁ and a first vibrating area B₁. The second electret film 16 has a second attaching area A₂ and a second vibrating area B₂ as well. When the post elements 222, 262 are arranged at the aforesaid width W₁, W₂, space S₁, S₂, height d₁, d₂ and the first electret film 12 and the second electret film 16 do not vibrate (no audio signal input), a distance L₁ between an edge of the first attaching region A₁ and the corresponding post element 222 is 2 to 30 times of the height d₁ of the corresponding post element 222; a distance L₂ between an edge of the second attaching region B₁ and the corresponding post element 262 is 2 to 30 times of the height d₂ of the corresponding post element 262. Meanwhile, the first electret film 12 and the first spacer 22 define a first interior angle φ between 60 to 80 degrees; the second electret film 16 and the second spacer 26 define a second interior angle θ between 60 to 80 degrees.

At this point, the first electret film 12 and the second electret film 16 have an optimized vibrating region to improve the range of frequencies and efficiency of the flexible speaker 10.

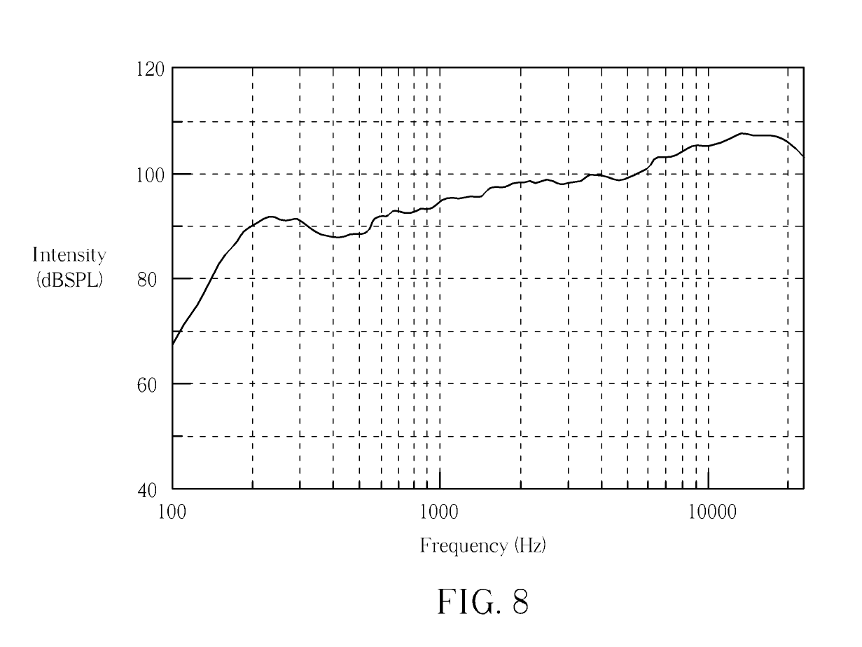

FIG. 8 depicts a relation between intensity vs. frequency of the flexible speaker according to a first preferred embodiment. As shown in FIG. 8, the flexible spacer 10 is a good mid-high range speaker which produces great audible frequency between 200 Hz to 30 kHz.

Those skilled in the art will readily observe that numerous modifications and alterations of the device and method may be made while retaining the teachings of the invention.

What is claimed is:

1. A structure of flexible speaker, comprising:
a first electret film including a first surface;
a second electret film including a second surface;
a conductive film disposed between the first electret film and the second electret film;
a first spacer including a plurality of strip elements disposed on the first surface of the first electret film for supporting a first electrode, wherein the first electret film and the first spacer define a first interior angle between 60 to 88 degrees; and
a second spacer disposed on the second surface of the second electret film for supporting a second electrode.

2. The structure of flexible speaker of claim 1, wherein the second electret film and the second spacer define a second interior angle between 60 to 88 degrees.

3. The structure of flexible speaker of claim 1, wherein the plurality of strip elements forms a grid pattern including a plurality of regions.

4. The structure of flexible speaker of claim 3, wherein the shape of each of the regions is selected from the group consisting of circle, rectangular, ellipse and polygon.

5. The structure of flexible speaker of claim 3, wherein the regions near an edge of the first electret film are larger than the regions farther from the edge of the first electret film.

6. The structure of flexible speaker of claim 3, wherein the size of each of the plurality of regions is substantially identical.

7. The structure of flexible speaker of claim 1, wherein a width of each of the plurality of strip elements is between 2 to 10 mm.

8. The structure of flexible speaker of claim 1, wherein a space is between two adjacent strip elements, and the space is 8 to 100 mm.

9. The structure of flexible speaker of claim 1, wherein a height of each of strip elements is between 50 to 1500 μm.

10. The structure of flexible speaker of claim 1, wherein the first spacer is formed by a material selected from the group consisting of rubber, silica gel, glue, hot melt adhesive, double sided tape and plastic.

11. The structure of flexible speaker of claim 1, wherein the first electret film includes a first attaching region contacting the first electrode.

12. The structure of flexible speaker of claim 11, wherein the first electret film includes a first vibrating region which does not contact the first electrode, and the first vibrating region vibrates when the first electrode receives an audio signal.

13. The structure of flexible speaker of claim 1, wherein the second electret film includes a second attaching region contacting the second electrode.

14. The structure of flexible speaker of claim 13, wherein the second electret film includes a second vibrating region which does not contact the second electrode, and the second vibrating region vibrates when the second electrode receives an audio signal.

15. The structure of flexible speaker of claim 1, wherein the first electret film and the second electret film are selected independently from the group consisting of polytetrafluoroethylene, fluorinated ethylene propylene, polyvinylidene fluoride, fluoroploymer, polypropylene, polyethylene, polyimide, cyclic olefin copolymer, and complex of the cyclic olefin copolymer.

16. The structure of flexible speaker of claim 1, further comprising an insulating material sealing edges of the flexible speaker so as to avoid the first electrode separating from the first spacer, and to avoid the second electrode separating from the second spacer.

17. A structure of flexible speaker, comprising:
a first electret film including a first surface;
a second electret film including a second surface;
a conductive film disposed between the first electret film and the second electret film;
a first spacer including a plurality of post elements disposed on the first surface of the first electret film for supporting a first electrode, wherein the first electret film and the first spacer define a first interior angle between 60 to 88 degrees; and
a second spacer disposed on the second surface of the second electret film for supporting a second electrode.

18. The structure of flexible speaker of claim 17, wherein the shape of a cross-section of each of the post elements is selected from the group consisting of circle, rectangular, ellipse and polygon.

19. The structure of flexible speaker of claim 17, wherein a cross-sectional area of each of the post elements is 0.5 to 15 mm².

20. The structure of flexible speaker of claim 17, wherein a space is between two adjacent post elements, and the space is 8 to 100 mm.

21. The structure of flexible speaker of claim 20, wherein the space between two adjacent post elements near an edge of the first electret film is larger than the space between two adjacent post elements farther from the edge of the first electret film.

22. The structure of flexible speaker of claim 20, wherein the space between two adjacent post elements is substantially identical.

23. The structure of flexible speaker of claim 17, wherein a height of each of the post elements is between 50 to 1500 μm.

24. The structure of flexible speaker of claim 17, wherein the first spacer is formed by a material selected from the group consisting of rubber, silica gel, glue, hot melt adhesive, double sided tape and plastic.

25. The structure of flexible speaker of claim 17, wherein the first electret film includes a first attaching region contacting the first electrode.

26. The structure of flexible speaker of claim 17, wherein the first electret film includes a first vibrating region which does not contact the first electrode, and the first vibrating region vibrates when the first electrode receives an audio signal.

27. The structure of flexible speaker of claim 17, wherein the second electret film includes a second attaching region contacting the second electrode.

28. The structure of flexible speaker of claim 27, wherein the second electret film includes a second vibrating region which does not contact the second electrode, and the second vibrating region vibrates when the second electrode receives an audio signal.

29. The structure of flexible speaker of claim 17, wherein the first electret film and the second electret film are selected independently from the group consisting of polytetrafluoroethylene, fluorinated ethylene propylene, polyvinylidene fluoride, fluoroploymer, polypropylene, polyethylene, polyimide, cyclic olefin copolymer, and complex of the cyclic olefin copolymer.

30. The structure of flexible speaker of claim 17, further comprising an insulating material sealing edges of the flexible speaker so as to avoid the first electrode separating from the first spacer, and to avoid the second electrode separating from the second spacer.
